(19) United States
(12) Patent Application Publication
(10) Pub. No.: US 2010/0250135 A1
(43) Pub. Date: Sep. 30, 2010

(54) Method and Device for Determining Proximity of a Social Network Service Acquaintance

(75) Inventors: Xiang-Ming Li, Nanjing (CN); Zong-Hua Liu, Nanjing (CN); Cheng Yang, Nanjing (CN)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumburg, IL (US)

(21) Appl. No.: 12/411,943

(22) Filed: Mar. 26, 2009

(51) Int. Cl. G06F 17/00

(52) U.S. Cl. 701/300

(57) ABSTRACT

A method and device enables an efficient determination of a proximity of a social network service acquaintance. The method includes transmitting an inquiry message from the electronic device during a device proximity discovery process (step 405). An inquiry response message is then received in response to the inquiry message, where the inquiry response message includes a received social network service identifier associated with the social network service acquaintance (step 410). Next, a proximity of the social network service acquaintance is determined by matching the received social network service identifier with a stored social network service identifier (step 415). An output is then provided at the electronic device in response to matching the received social network service identifier (step 420).

### FIELD OF THE DISCLOSURE

The present invention relates generally to wireless communication networks, and in particular to determining proximity of social network service acquaintances by processing inquiry response messages received during device proximity discovery processes.

### BACKGROUND

Users continually seek increased functionality from portable electronic devices. For example, mobile telephones are increasingly multi-function devices that can include, in addition to wireless telephony services, functions and applications commonly associated with digital music players, personal digital assistants, notebook computers, and various other devices. Mobile telephones often include applications for media playing, calendaring, personal information management, internet browsing, and processing emails. Further, mobile telephones are increasingly being used to access social networking applications.

Social networking applications are generally software applications that enable people having shared interests to interact and build online communities. Users are generally tied directly to other users through acquaintance lists or “friends” lists. Social networks then can grow and complex social relationships can be explored using indirect ties such as “acquaintances of acquaintances” or “friends of friends”. Many social networking applications are Internet based and allow users to interact electronically using email and instant messaging services. Further, some social networking applications provide services for assisting users to locate each other geographically and meet in person.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a message sequence chart illustrating a method for using a Bluetooth® discovery process of an electronic device to determine proximity of a social network service acquaintance.

FIG. 2 is a diagram illustrating an example of the Bluetooth® extended inquiry response (EIR) message transmitted during the Bluetooth® discovery process shown in FIG. 1.

FIG. 3 is a block diagram illustrating components of an electronic device.

FIG. 4 is a general flow diagram illustrating a method for using an electronic device to determine proximity of a social network service acquaintance.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

According to some embodiments of the present invention, a method is provided for using an electronic device to determine proximity of a social network service acquaintance. The method includes transmitting an inquiry message from the electronic device during a device proximity discovery process. An inquiry response message is then received in response to the inquiry message, where the inquiry response message includes a received social network service identifier associated with the social network service acquaintance. Next, a proximity of the social network service acquaintance is determined by matching the received social network service identifier with a stored social network service identifier. An output is then provided at the electronic device in response to matching the received social network service identifier.

Embodiments of the present invention thus enable acquaintances in a social network, who may have previously interacted only online and thus may not be able to recognize each other, to be notified when they are within a physical proximity to each other. Access to network resources such as a centralized server or geographic location applications are not required, and thus limited power and processing resources of a device can be conserved. Further, operation of some embodiments of the present invention can be very effective in locations having weak cellular network signal strength, such as indoors.

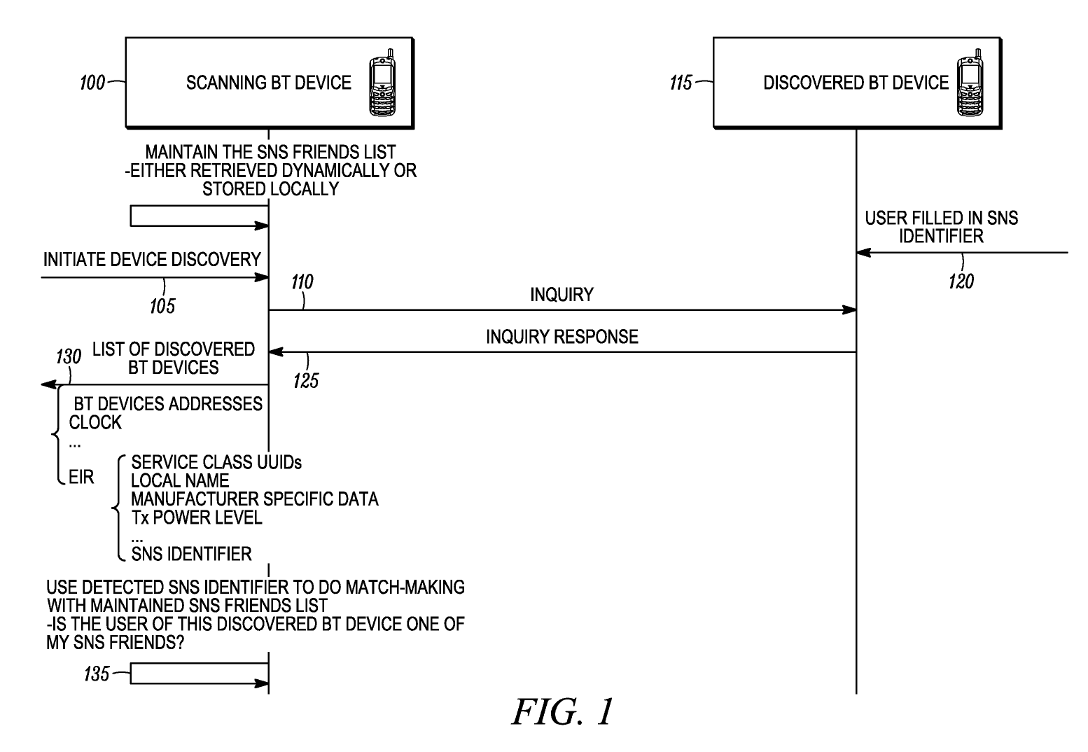

Referring to FIG. 1, a message sequence chart illustrates a method for using an electronic device to determine proximity of a social network service acquaintance, according to some embodiments of the present invention. Consider, for example, that an electronic device 100 in the form of a mobile telephone maintains a social network service “friends” list. As will be understood by those having ordinary skill in the art, such a friends list may be stored in a local memory of the electronic device 100, or may be stored at a remote server that can be accessed wirelessly by the electronic device 100.

At line 105, the electronic device 100 initiates a device discovery process. For example, if the electronic device 100 has short range communication link capabilities, such as Bluetooth® short range wireless capabilities, the device discovery process can begin with the electronic device initiating a short range signal communication link inquiry substate. The electronic device 100 then broadcasts a Bluetooth® inquiry message 110. Bluetooth® signals generally have a range of about ten meters, thus any other Bluetooth® enabled devices within this range will receive the inquiry message 110. As used herein, short range communication links have a transmission area proximate the user or generally within a facility in which a user is located, such as local area networks, as distinguished from long range communication links associated with a wide area network such as cellular and satellite communication systems.

For example, consider that another electronic device 115, such as another Bluetooth® enabled mobile telephone, receives the inquiry message 110. Further, at line 120, consider that a user of the electronic device 115 has both enabled the electronic device 115 to be discoverable by other devices and has indicated that a social network service identifier should be included in a response to received Bluetooth® inquiry messages. The electronic device 115 therefore transmits a short range radio frequency extended inquiry response (EIR) message 125 to the electronic device 100, where the EIR message 125 includes the social network service identifier associated with the user of the electronic device 115.

At line 130, the electronic device 100 processes the EIR message 125. Processing the EIR message 125 may include reading various data concerning the electronic device 115 included in the EIR message 125, such as address and clock data, service class universally unique identifiers (UUIDs), local name, manufacturer specific data, transmission power level, and the social network service identifier that was added at line 120.

At line 135, the electronic device 100 processes the social network service identifier received in the EIR message 125. For example, the electronic device 100 can determine whether the social network service identifier received in the EIR message 125 matches a social network service identifier maintained in the “friends” list of the user of the electronic device 100. If so, then the electronic device 100 can provide an alert to the user that indicates that another device that is associated with a friend of the user is presently within the Bluetooth® ten meter range of the electronic device 100. For example, such an alert to the user of the electronic device 100 can include any of various outputs at the electronic device 100, including emitting an audible ring tone, vibrating the electronic device 100, or providing a visual display to the user. For example, providing an output at the electronic device 100 in response to matching a received social network service identifier can include displaying identification information concerning the acquaintance on a display screen of the electronic device 100.

Examples of social network services include MySpace®, Facebook®, Google® Talk, Yahoo Messenger, MSN®, Linkedin®, QQ, and the like. Those skilled in the art will recognize that many other examples exist. According to some embodiments of the present invention, a user of the electronic device 100 may have one social network service identifier, such as an email address, for all of their social network service accounts. Alternatively, a user may have a unique social network service identifier for each of their social network service accounts. For example, a single social network service identifier for multiple social network service accounts could be johndoe@gmail.com; and a unique social network service identifier for a specific QQ account could be QQ123456789.

A user may enter his or her own social network service identifier into the electronic device 100 in various ways such as manually using a keypad or other interface of the electronic device 100, or automatically by downloading the social network service identifier from a server. For example, a social network service identifier may be downloaded from a social network service provider as a component of a participant profile. Further, a social network service identifier, such as an email address, can be used as a general identifier of the electronic device 100. For example, the email address johngdoe@gmail.com can be used as a Bluetooth® device name of the electronic device 100.

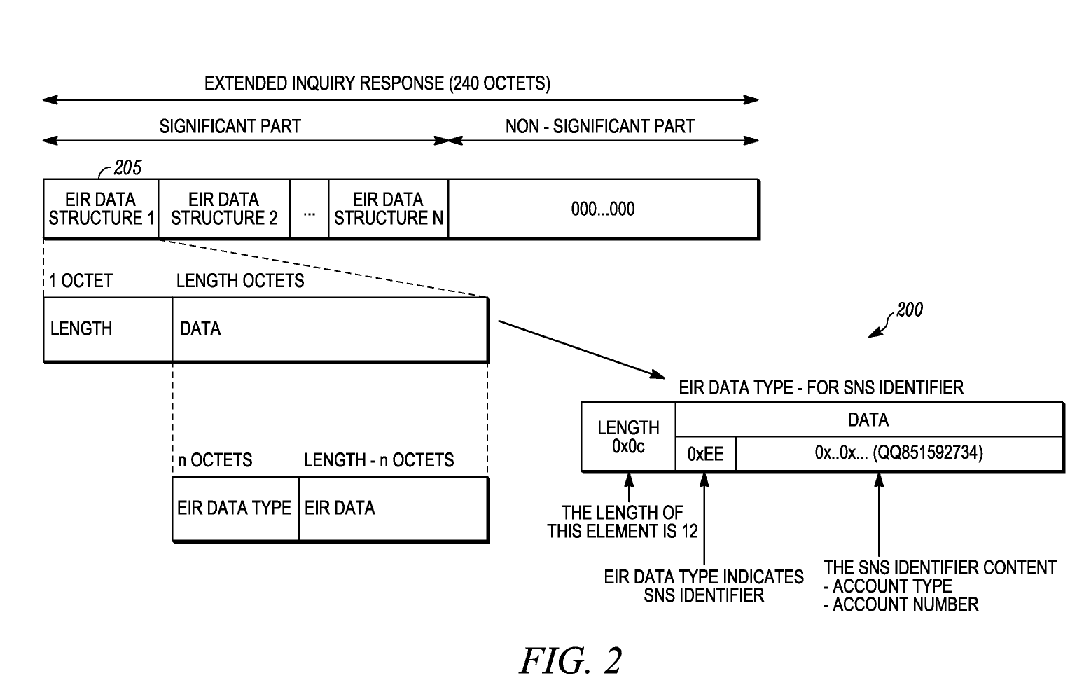

Referring to FIG. 2, a diagram illustrates one example of a short range communication link signal, such as the Bluetooth® EIR message 125 transmitted during the Bluetooth® discovery process shown in FIG. 1. The EIR message 125 may include a 50 octet EIR data field 200 that contains the social network service identifier including, for example, an account type and an account number. The EIR data field 200 is included as a data element in an EIR data structure 205. For example, the EIR data field 200 can be standardized in a Bluetooth® specification that defines the EIR data structure 205. Advantageously, multiple social network service identifiers can be included in the EIR data structure 205 depending on available space.

As will be understood by those having ordinary skill in the art, alternative embodiments of the present invention can utilize various other short-range wireless technologies including, for example, wireless local area network (WLAN) technologies, technologies that use infrared data association (IrDA) wireless standards, dedicated short range communication (DSRC) wireless standards, ZigBee wireless standards, and Institute of Electrical and Electronics Engineers (IEEE) 802.11 wireless standards. (Note: for any IEEE standards recited herein, see: http://standards.ieee.org/getieee802/index.html or contact the IEEE at IEEE, 445 Hoes Lane, PO Box 1331, Piscataway, N.J. 08855-1331, USA).

Further, according to some embodiments of the present invention, to assist in protecting the privacy of users a social network service identifier can be encrypted in an inquiry response message. Means for decrypting the social network service identifier then can be provided to social network service acquaintances using conventional online social network service messages or Internet pages. For example, exclusive access to public key infrastructure (PKI) private keys can be provided to a user's social network service acquaintances via the user's social network service. It is envisioned that the shared private key will be stored in their respective devices and associated with the user's social network service identifier whereby upon receipt of a request from a user will result in selection of the associated key. Upon receipt of the reply, the user's device will use the private key to decrypt the social network service identifier embedded in the reply. Advantageously, the shared private key can be used to encrypt communication exchanges between identified social network service acquaintances to provide added security for their communications exchanged following identification of proximate social network services acquaintances.

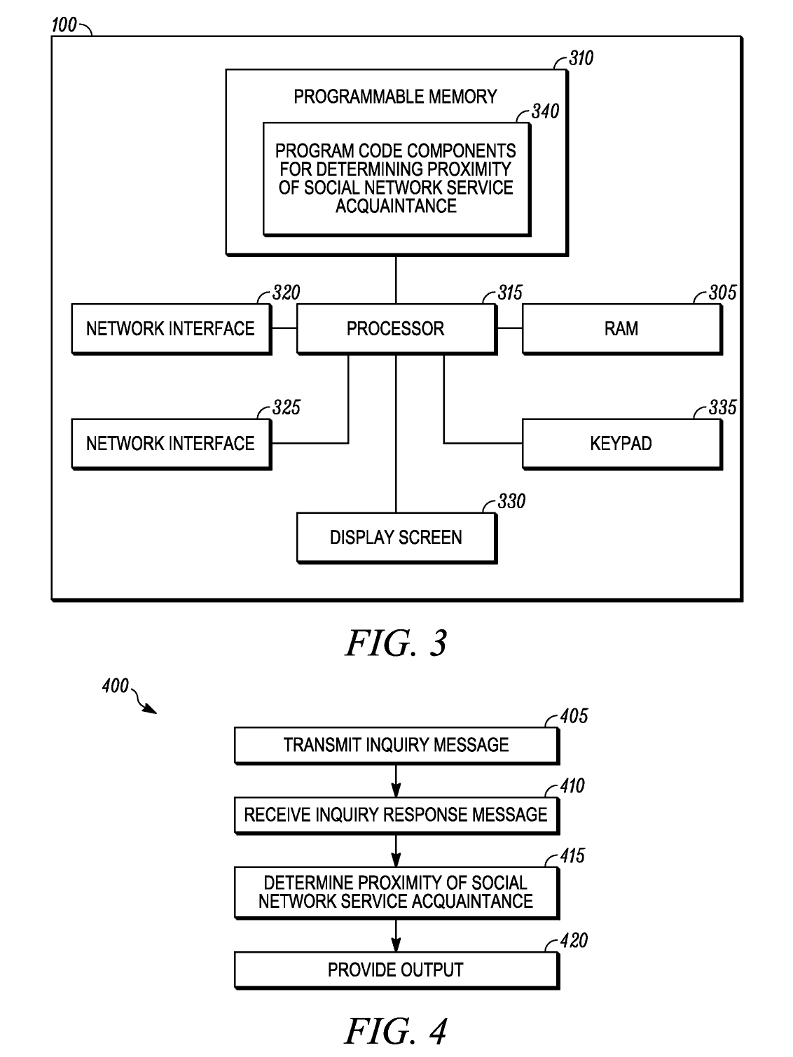

Referring to FIG. 3, a block diagram illustrates components of the electronic device 100, according to some embodiments of the present invention. The electronic device 100, for example, can comprise a mobile telephone containing at least all the elements depicted in FIG. 3, as well as any other elements necessary for the electronic device 100 to perform its particular functions. Alternatively, the electronic device 100 can comprise a collection of appropriately interconnected units or devices, wherein such units or devices perform functions that are equivalent to the functions performed by the elements depicted in FIG. 3.

The electronic device 100 comprises a random access memory (RAM) 305 and a programmable memory 310 that are coupled to a processor 315. The processor 315 also has ports for coupling to network interfaces 320, 325. The network interfaces 320, 325 can be used to enable the electronic device 100 to communicate with other devices in various types of wired or wireless communication networks. For example the network interface 320 may be a Bluetooth® wireless interface that enables the electronic device 100 to transmit the inquiry message 110 to the electronic device 115 and receive the EIR message 125 from the electronic device 115. The processor 315 is also coupled to a display screen 330 and to a keypad 335 for entering data into the electronic device 100.

The programmable memory 310 can store operating code (OC) for the processor 315 and code for performing functions associated with a network device. For example, the programmable memory 310 can store computer readable program code components 340 configured to cause execution of a method for using the electronic device 100 to determine proximity of a social network service acquaintance, as described herein. Further, the programmable memory 310 can store one or more social network service friends lists, where each list includes one or more social network service identifiers of social network service acquaintances.

Referring to FIG. 4, a general flow diagram illustrates a method 400 for using an electronic device to determine proximity of a social network service acquaintance, according to some embodiments of the present invention. At step 405 an inquiry message is transmitted from the electronic device during a device proximity discovery process. For example, the electronic device 100 transmits the Bluetooth® inquiry message 110 to the electronic device 115, as described above.

At step 410, an inquiry response message is received in response to the inquiry message, wherein the inquiry response message includes a received social network service identifier associated with the social network service acquaintance. For, example, the extended inquiry response (EIR) message 125 is received at the electronic device 100 in response to the inquiry message 110, and the EIR message 125 includes the social network service identifier associated with the user of the electronic device 115 and defined in the EIR data field 200, as described above.

At step 415, proximity of the social network service acquaintance is determined by matching the received social network service identifier with a stored social network service identifier. For example, at line 135 of FIG. 1, the electronic device 100 matches the social network service identifier received in the EIR message 125 with a social network service identifier maintained in the “friends” list of the user of the electronic device 100.

At step 420, an output is provided at the electronic device in response to matching the received social network service identifier. For example, as described above, the electronic device 100 may provide an audible alert after matching the social network service identifier received in the EIR message 125 with a social network service identifier maintained in the “friends” list of the user of the electronic device 100.

Advantages of some embodiments of the present invention therefore include enabling acquaintances in a social network, who may have previously interacted only online and thus may not be able to recognize each other, to be notified when they are within a physical proximity to each other. Access to network resources such as a centralized server or geographic location applications are not required, and thus limited power and processing resources of a device can be conserved. Further, as some embodiments of the present invention include direct peer to peer wireless connectivity between devices, some embodiments of the present invention can be very effective in locations having weak cellular network signal strength, such as indoors.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the present teachings. The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims as issued.

Moreover, in this document relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, or contains a list of elements does not include only those elements but may include other elements not expressly listed or inherent to such process, method, article, or apparatus. An element preceded by “comprises a . . . ”, “has a . . . ”, “includes a . . . ”, or “contains a . . . ” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and system described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for using an electronic device to determine proximity of a social network service acquaintance, the method comprising:
transmitting an inquiry message from the electronic device during a device proximity discovery process;
receiving by the electronic device an inquiry response message in response to the inquiry message, wherein the inquiry response message includes a received social network service identifier associated with the social network service acquaintance;
determining proximity of the social network service acquaintance by matching the received social network service identifier with a stored social network service identifier; and
providing an output at the electronic device in response to matching the received social network service identifier.

2. The method of claim 1, wherein the inquiry response message is a short range radio frequency signal extended inquiry response (EIR) message.

3. The method of claim 1, wherein the received social network service identifier comprises a short range communication link extended inquiry response (EIR) data type value.

4. The method of claim 1, wherein the device proximity discovery process is a short range communication link discovery procedure.

5. The method of claim 1, wherein the received social network service identifier is encrypted in the inquiry response message.

6. The method of claim 1, wherein providing the output at the electronic device in response to matching the received social network service identifier comprises displaying identification information concerning the acquaintance on a display screen of the electronic device.

7. The method of claim 1, wherein the stored social network service identifier is stored locally in a memory of the electronic device.

8. An electronic device, comprising:
a processor; and
a memory coupled to the processor, wherein the memory comprises:
computer readable program code components for transmitting an inquiry message from the electronic device during a device proximity discovery process;
computer readable program code components for receiving an inquiry response message in response to the inquiry message, wherein the inquiry response message includes a received social network service identifier associated with the social network service acquaintance;
computer readable program code components for determining proximity of the social network service acquaintance by matching the received social network service identifier with a stored social network service identifier; and
computer readable program code components for providing an output at the electronic device in response to matching the received social network service identifier.

9. The device of claim 8, wherein the inquiry response message is a short range radio frequency signal extended inquiry response (EIR) message.

10. The device of claim 8, wherein the received social network service identifier comprises a short range communication link extended inquiry response (EIR) data type value.

11. The device of claim 8, wherein the device proximity discovery process is a short range communication link discovery procedure.

12. The device of claim 8, wherein the received social network service identifier is encrypted in the inquiry response message.

13. The device of claim 8, wherein providing the output at the electronic device in response to matching the received social network service identifier comprises displaying identification information concerning the acquaintance on a display screen of the electronic device.

14. The device of claim 8, wherein the stored social network service identifier is stored locally in a memory of the electronic device.

15. An electronic device, comprising:
means for transmitting an inquiry message from the electronic device during a device proximity discovery process;
means for receiving an inquiry response message in response to the inquiry message, wherein the inquiry response message includes a received social network service identifier associated with the social network service acquaintance;
means for determining proximity of the social network service acquaintance by matching the received social network service identifier with a stored social network service identifier; and
means for providing an output at the electronic device in response to matching the received social network service identifier.
